(19) United States
(12) Patent Application Publication
(10) Pub. No.: US 2013/0010316 A1
(43) Pub. Date: Jan. 10, 2013

(54) INFORMATION PROCESSING APPARATUS, CONTROL METHOD THEREFOR, AND COMPUTER-READABLE MEDIUM

(75) Inventor: Akihiko Tokuda, Yokohama-shi (JP)

(73) Assignee: CANON KABUSHIKI KAISHA, Tokyo (JP)

(21) Appl. No.: 13/525,000

(22) Filed: Jun. 15, 2012

(30) Foreign Application Priority Data
Jul. 8, 2011 (JP) 2011-152344

(51) Int. Cl. G06K 15/00

(52) U.S. Cl. 358/1.13

(57) ABSTRACT

An information processing apparatus including a printer driver for a printing apparatus that supports a first data format and an application for generating data in accordance with the data format supported by the printing apparatus, comprises: a determination unit that determines whether the printing apparatus supports a second data format; and a transmission unit that transmit, to the printing apparatus, data generated by the application in the second data format that contains data in the first data format as it is if the printing apparatus supports the second data format, and converts data generated by the application in the second data format into the first data format using a function of the printer driver and transmits the converted data to the printing apparatus if the printing apparatus does not support the second data format.

### BACKGROUND OF THE INVENTION

1. Field of the Invention

The present invention relates to an information processing apparatus, a control method therefor, and a computer-readable medium. In particular, the present invention relates to a technique used to generate print data and transmit the data to a printing apparatus such as a digital copy machine connected to a client computer.

2. Description of the Related Art

Conventionally, a printer driver on a client computer receives a print instruction from various applications installed on the client computer, and generates print data for a printer connected to a network. Some applications can directly generate print data in a printer language that can be processed by a printer without causing a printer driver to generate print data. The print data generated by such applications can be transmitted directly to the printer via the printer driver. In the present specification, such an application is hereinafter referred to as a pass-through application.

Adobe's Acrobat (R) is one of the typical pass-through applications. At the time of executing printing, a pass-through application such as Acrobat (R) inquires of a printer driver about whether or not the printer driver used for printing can handle PostScript (hereinafter referred to as PS) Pass-Through. If the printer driver that receives the inquiry can handle PS Pass-Through, the printer driver replies to the application that made the inquiry that it can handle PS Pass-Through. In this case, the pass-through application generates a PS command on its own that can be processed by the printer. Then, the pass-through application transmits the PS format data as it is to the printer designated as a port of the printer driver that can handle PS Pass-Through.

There are various manners in which the pass-through application inquires about whether or not a printer driver used for printing can handle PS Pass-Through. For example, on Windows (R), the pass-through application determines whether or not the printer driver can handle PS Pass-Through by referring to the settings of POSTSCRIPT_PASSTHROUGH that is a printer escape function.

Meanwhile, if the printer driver does not support PS Pass-Through, a print data generation command is issued to the printer driver using a rendering mode that is defined on the operating system (hereinafter referred to as OS) on the client computer and is standard for the OS. The printer driver that can handle PS Pass-Through can also intentionally turn “off” the settings of POSTSCRIPT_PASSTHROUGH. In this case, the PS Pass-Through application issues a print command in an OS standard rendering mode. In other words, even if the printer driver can handle PS Pass-Through, it is possible to adopt a rendering mode similar to one used by printer drivers that do not support PS Pass-Through.

Japanese Patent Laid-Open No. 2007-226809 discloses a technique with which if an application generates PS format data and a non-PS printer that does not support PS is designated in a computer, a printing system converts the PS format data and generates non-PS data such as PCL and PJL.

When the print data generated by the pass-through application is transmitted to a printer, in some cases the print data generated by the printer driver is limited to a specific format (hereinafter referred to as fixed format). If the OS that configures a printing system is Windows (R), examples of such a fixed format include EMF (Enhanced Metafile) and XPS (XML Paper Specification). For example, it can be assumed that this printing system is consistently configured to handle print data in the XPS format that serves as a fixed format.

Printing systems with such conditions have a problem of impossibility of implementing, for example, the pass-through printing using above-mentioned PS.

### SUMMARY OF THE INVENTION

According to one aspect of the present invention, there is provided an information processing apparatus including a printer driver for a printing apparatus that supports a first data format and an application for generating data in accordance with the data format supported by the printing apparatus, the information processing apparatus comprising: a determination unit configured to determine whether or not the printing apparatus supports a second data format; and a transmission unit configured to transmit, to the printing apparatus, data generated by the application in the second data format that contains data in the first data format as it is if the determination unit determines that the printing apparatus supports the second data format, and convert data generated by the application in the second data format into the first data format using a function of the printer driver and transmit the converted data to the printing apparatus if the determination unit determines that the printing apparatus does not support the second data format.

According to another aspect of the present invention, there is provided a method for controlling an information processing apparatus including a printer driver for a printing apparatus that supports a first data format and an application for generating data in accordance with the data format supported by the printing apparatus, the method comprising: determining whether or not the printing apparatus supports a second data format; and transmitting, to the printing apparatus, data generated by the application in the second data format that contains data in the first data format as it is if it is determined during the determining that the printing apparatus supports the second data format, and converting data generated by the application in the second data format into the first data format using a function of the printer driver and transmitting the converted data to the printing apparatus if it is determined during the determining that the printing apparatus does not support the second data format.

According to another aspect of the present invention, there is provided a computer-readable medium storing a program for causing a computer to function as: a determination unit configured to determine whether or not the printing apparatus, which supports a first data format, supports a second data format; and a transmission unit configured to transmit, to the printing apparatus, data generated by the application in the second data format that contains data in the first data format as it is if the determination unit determines that the printing apparatus supports the second data format, and convert data generated by the application in the second data format into the first data format and transmit the converted data to the printing apparatus if the determination unit determines that the printing apparatus does not support the second data format.

With the present invention, a client apparatus can generate print data in a data format that can be handled by a printing apparatus.

Further features of the present invention will become apparent from the following description of exemplary embodiments (with reference to the attached drawings).

### BRIEF DESCRIPTION OF THE DRAWINGS

FIG. 1 is a diagram showing an exemplary configuration of a printing system.

FIG. 2 is a block diagram showing an exemplary configuration of a client computer.

FIG. 3 is a diagram showing an exemplary module configuration of a printer driver.

FIG. 4 is a flowchart illustrating a process of installing the printer driver.

FIG. 5 is an exemplary conventional configuration of a printing system.

FIG. 6 is a schematic diagram showing a printing system according to the first embodiment.

FIG. 7 is a flowchart according to the first embodiment.

FIG. 8 is a diagram showing transition and a configuration of print data according to the first embodiment.

FIG. 9 is a schematic diagram showing a printing system according to the second embodiment.

FIG. 10 is a flowchart according to the second embodiment.

FIG. 11 is a diagram showing transition and a configuration of print data according to the second embodiment.

### DESCRIPTION OF THE EMBODIMENTS

### First Embodiment

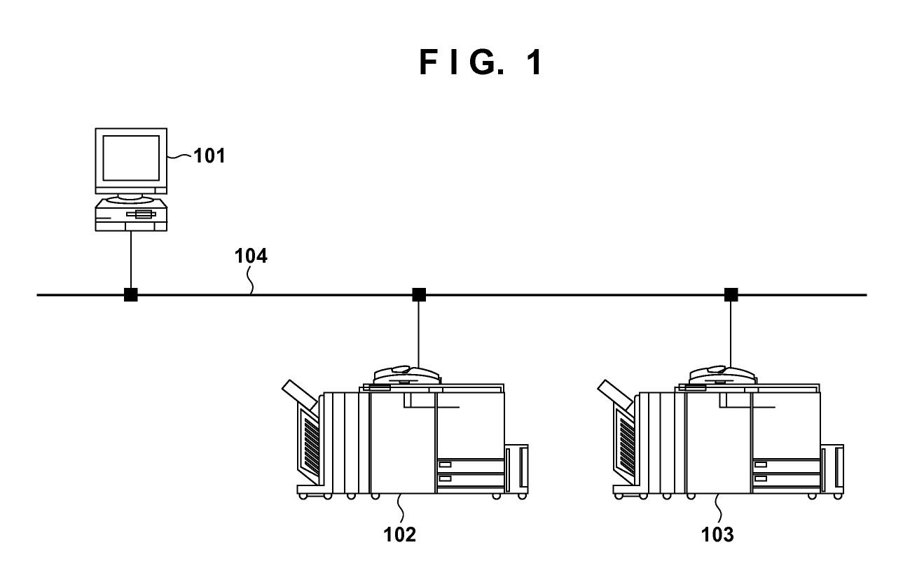

FIG. 1 to FIG. 8 depict the first embodiment of the present invention.

System Configuration

FIG. 1 is a diagram showing an exemplary configuration of a printing system to which the present invention can be applied. Referring to FIG. 1, a client computer 101 that is an information processing apparatus and printers 102 and 103 that are printing apparatuses are connected to each other via a network 104. An operating system (hereinafter referred to as OS), an application, and a printer driver have been installed on the client computer 101. In this printing system, a user can transmit print data from the client computer 101 to the printers 102 and 103 and print the print data.

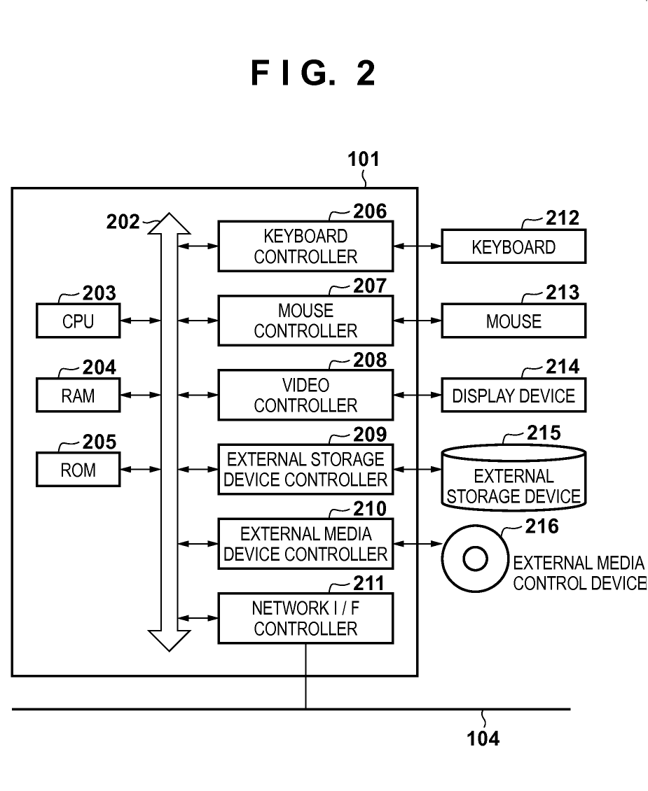

FIG. 2 is an internal block diagram of the client computer 101. The client computer 101 is internally provided with a central processing unit (CPU) 203, a RAM 204 that is a volatile memory, and a ROM 205 that is a nonvolatile memory. The client computer 101 further has a keyboard controller 206, a mouse controller 207, a video controller 208, an external storage device controller 209, an external media device controller 210, and a network I/F controller 211. A keyboard 212 and a mouse 213 used by a user to operate the client computer 101 are connected to the keyboard controller 206 and the mouse controller 207, respectively. A display device 214 is connected to the video controller 208.

A nonvolatile external storage device 215 for storing a large volume of data is connected to the external storage device controller 209, and reading and writing of applications and data are performed. If an application, driver software, or the like is provided in the form of a medium (CD-ROM or DVD-ROM), the external media device controller 210 can load programs from the medium set in an external media control device 216. The client computer 101 is connected to the network 104 mentioned referring to FIG. 1 via the network I/F controller 211 and communicates with other devices.

Generally, an initial program for booting the client computer 101 and basic programs (not shown) for controlling modules in the client computer 101 are stored in the ROM 205. The OS, the application, and the printer driver are stored in the external storage device 215. After the client computer 101 is turned on, a program (boot loader) for booting the client computer 101 stored in the ROM 205 is first executed. Then, this program loads the OS stored in the external storage device 215 into the RAM 204, and passes the control to the OS. The OS loads necessary modules and drivers from the external storage device 215 into the RAM 204. In response to a user instruction, the OS further loads necessary applications from the external storage device 215 into the RAM 204 and executes those applications.

In the present embodiment, it is assumed that the printer driver and an installer for the printer driver are supplied in the form of an external medium such as a CD-ROM. Therefore, in response to a user setting a CD-ROM or the like in the external media control device 216, the CPU 203 loads it into the RAM 204 and stores it in the external storage device 215 as necessary.

Printer Driver

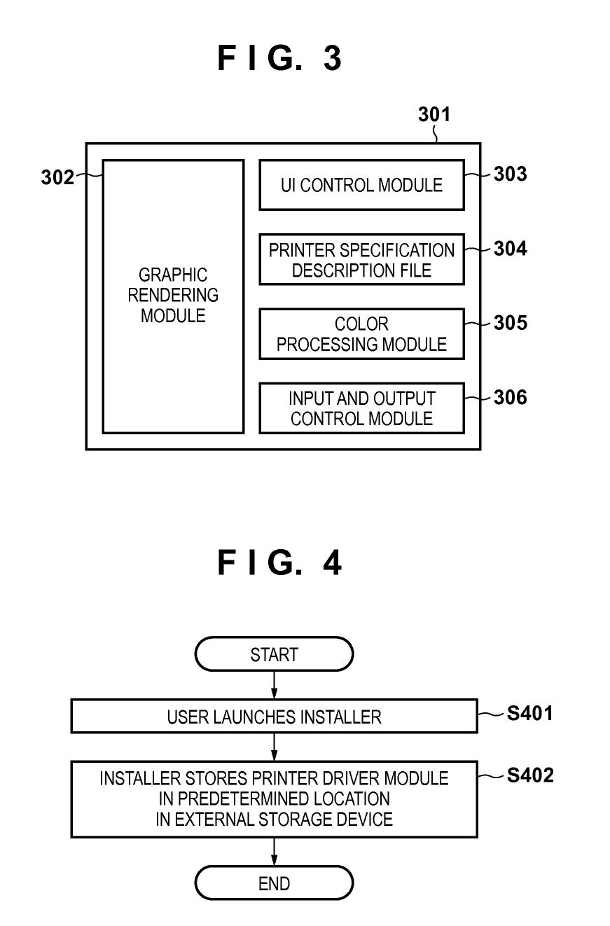

Next, the printer driver is described. The printer driver prepared when being installed includes, for example, a module group shown in FIG. 3. The printer driver 301 has a graphic rendering module 302, a UI control module 303, a printer specification description file 304, a color processing module 305, and an input and output control module 306. Note that the configuration is not limited thereto and it may include other modules depending on the function of the printer driver.

There are several manners of configuring the printer driver. For example, to handle a plurality of printers with a single printer driver, the printer driver is configured such that the graphic rendering module 302 and the UI control module 303 can handle a plurality of printers. Further, the same number of printer specification description files 304 as the printers handled is prepackaged contained in advance in the printer driver. With this manner, the UI control module 303 displays and controls a UI in accordance with each printer specification description file 304. The graphic rendering module 302 issues a PDL (Page Description Language) and a printer control command in accordance with each printer.

Printer Driver Installation

Next, a procedure of installing the printer driver having the above-described configuration on the client computer 101 is described. FIG. 4 shows the procedure of installing the printer driver. It is assumed that a user has prepared a CD-ROM in which the printer driver 301 is stored, or has acquired a printer driver installer (not shown) via the network.

At S401, the user launches the acquired printer driver installer (not shown). In response to this operation, at S402 the printer driver installer stores a printer driver module in a predetermined location in the external storage device 215. The storage location of the printer driver module depends on the printing system of the OS. For example, on Windows7 (R) the printer driver module is stored on a directory such as

“Windows¥system32¥spool¥drivers¥w32x86”

The printer driver installer stores the printer driver module on the predetermined directory as described above in the external storage device 215. Installation of the printer driver is thus completed.

Method for Holding a Content of Settings of the Printer Driver

The printer driver assigns initial setting information held internally by the driver at the time of installation to all contents of settings of the client computer 101. Those contents are registered in the following storage areas called registries, which are managed by the OS.

HKEY_CURRENT_USER¥Software
HKEY_LOCAL_MACHINE¥SOFTWARE¥
HKEY_LOCAL_MACHINE¥SYSTEM¥

In the present embodiment, a user interface application is also provided together with the printer driver. This user interface application, which has a function and operation described later, does not necessarily correspond one-to-one with the printer driver, and a single user interface application may correspond to a plurality of printer drivers. If a user interface application has been already installed on the client terminal at the time of installation of the printer driver, no additional user interface application needs to be installed.

Operation from Start to End of Printing (Conventional Example)

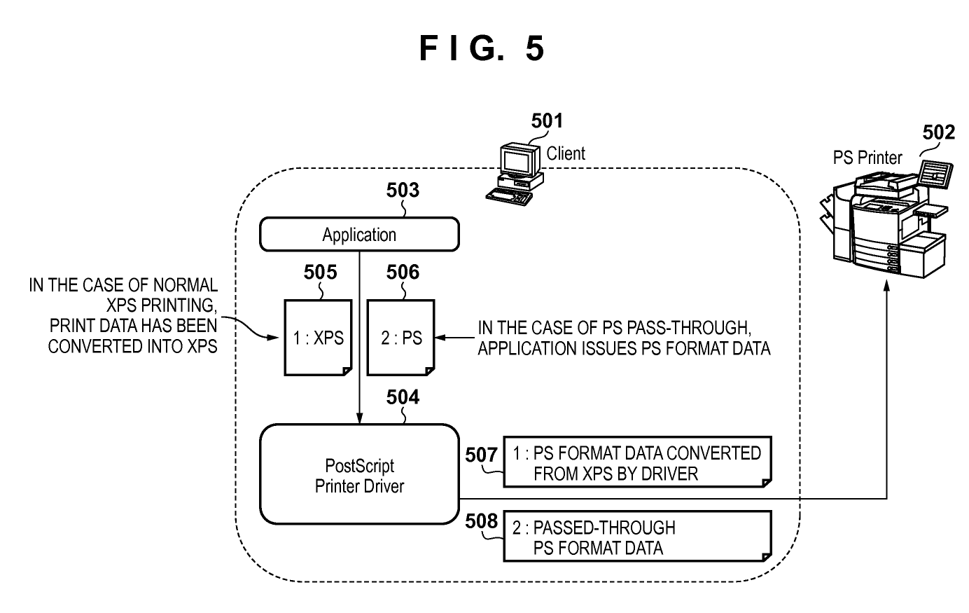

An operation from when a print instruction is started by the application until when a printing apparatus processes print data in the conventional technique is described with reference to FIG. 5. FIG. 5 is described assuming that the XPS (XML Paper Specification) is used as an example of the fixed format. In the following description, PS (PostScript) is used as the printer language supported by the printer 502.

An application 503 for document generation, drawing, spreadsheet, or the like has been installed on the client computer 501. If printing is executed by the application 503, an instruction to generate print data is given to the PS printer driver 504 installed on the client computer 501. At this time, as described above, if it is determined by the PS Pass-Through application that the PS printer driver 504 used for printing can handle PS Pass-Through, the application 503 generates print data 506 in the PS format on its own.

The PS printer driver 504 performs pass-through on the PS format print data 506 generated by the application 503. Specifically, the PS printer driver 504 transmits the PS format print data 506 generated by the application 503 as it is to a print port set as an output destination of the PS printer driver 504 without processing the PS format print data 506. Then, the printer 502 expands the print data into rendering data and executes printing based on the content of description of the passed-through PS format print data 508. At this time, the PS format print data 506 and the print data 508 shown in FIG. 5 are the same data.

Meanwhile, if it is determined that the printer driver used for printing cannot handle PS Pass-Through, the application 503 transmits print data 505 in the XPS format, which is a rendering data format standard for the OS, without generating PS format print data on its own. The application 503 then instructs the PS printer driver 504 to generate print data.

The PS printer driver 504 generates, based on the XPS format print data 505 transmitted by the application 503, print data 507 in the PS format, which is the printer language that can be interpreted by the printer 502. The printer 502 expands the print data into rendering data and executes printing based on the content of description of the PS format print data 507.

Note that examples of the method for instructing rendering used in Windows7 (R) or the like other than XPS may include GDI (Graphical Device Interface) that has been used in conventional OSes.

Operation from Start to End of Printing (the Present Invention)

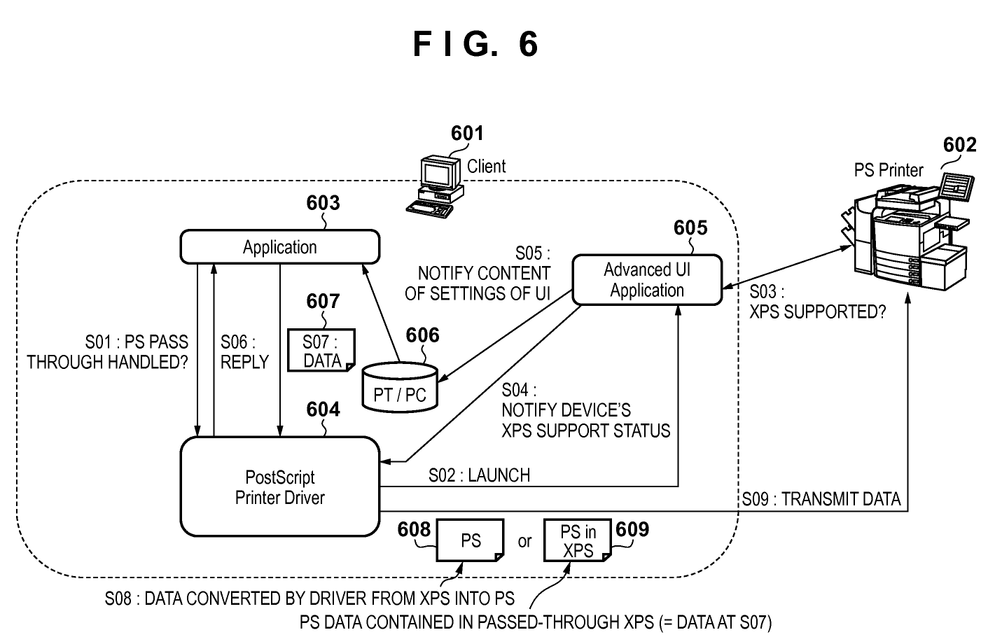

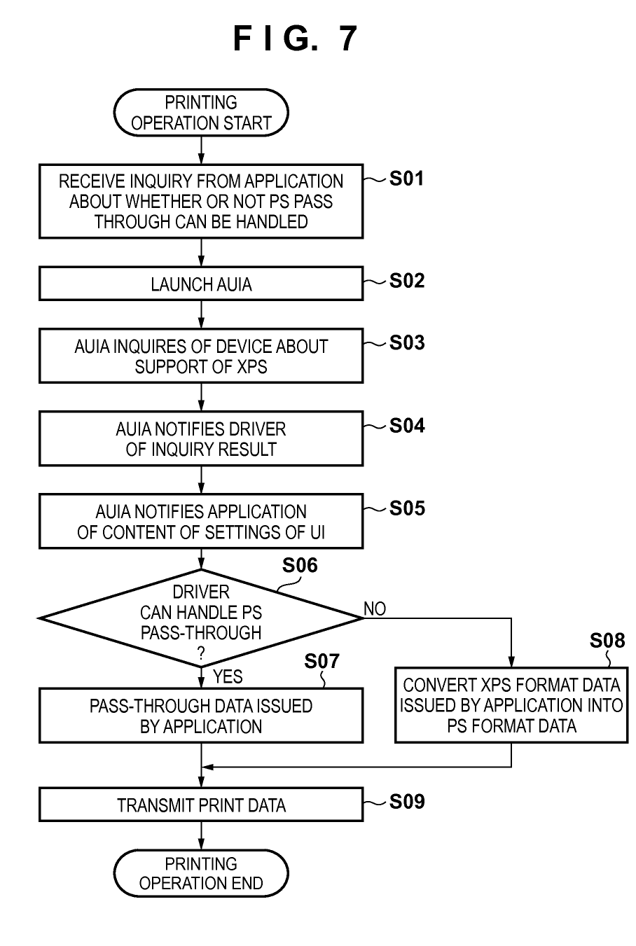

Here, the printing system that is an object of the present invention and in which print data is handled in the fixed format is shown in FIG. 6. Further, a flowchart used in the printing system is shown in FIG. 7. In FIG. 6 and FIG. 7, the same reference numeral indicates the same process. Also in this description, the fixed format (first data format) is XPS, and the printer language (second data format) is PS. It is assumed that the application 603 is a pass-through application and has a function capable of generating print data having a data structure where PS format data is contained in the fixed format.

Note that the term “contain” used here indicates to include, in print data in the fixed format (here, XPS), data in another format printer language (here, PS). In other words, the PS data is included in the XPS format data, thereby packaging the PS data. Thus the print data can be handled as the fixed format data. In the information processing apparatus, that print data is first handled as the fixed format print data, and then the printer can extract the contained print data in the printer language to perform processing.

The application 603 for document generation, drawing, spreadsheet, or the like has been installed on the client computer 601. If printing is executed from the application 603, an instruction to generate print data is given in advance to a PS printer driver 604 installed on the client computer 601. At this time, the PS printer driver 604 receives an inquiry from the application 603 about whether or not the PS printer driver 604 can handle PS Pass-Through (Step 01, hereinafter referred to as S01).

Upon receiving the above inquiry, the PS printer driver 604 launches a user interface application 605 (Advanced UI Application in FIG. 6, hereinafter referred to as AUIA) capable of changing various print settings and the like (S02). Then, the AUIA 605 inquires of the printer 602 designated in advance as a print destination about whether or not the printer 602 supports XPS (S03). Here, “inquiring about whether or not the XPS is supported” refers to, for example, inquiring about whether or not an XPS controller is mounted, or whether or not a module capable of interpreting XPS is available.

The AUIA 605, after acquiring information about whether or not the printer 602 used for printing supports XPS, notifies the PS printer driver 604 (S04). The AUIA 605 also generates setting information 606 necessary for generating print data, and passes to the application 603 the setting information together with the information about whether or not the printer 602 used for printing supports XPS (S05). The setting information 606 may include, for example, PrintTicket and PrintCapability (written as “PT/PC” in FIG. 6).

The PS printer driver 604 notifies the application 603 of a result of determination of whether or not the PS printer driver 604 can handle PS Pass-Through based on information received from the AUIA 605 about whether or not the printer 602 used for printing supports XPS (S06). In this embodiment, if the printer 602 used for printing supports XPS, the PS printer driver 604 notifies the application 603 that the PS printer driver 604 can handle PS Pass-Through. If not, the PS printer driver 604 notifies that it cannot handle PS Pass-Through.

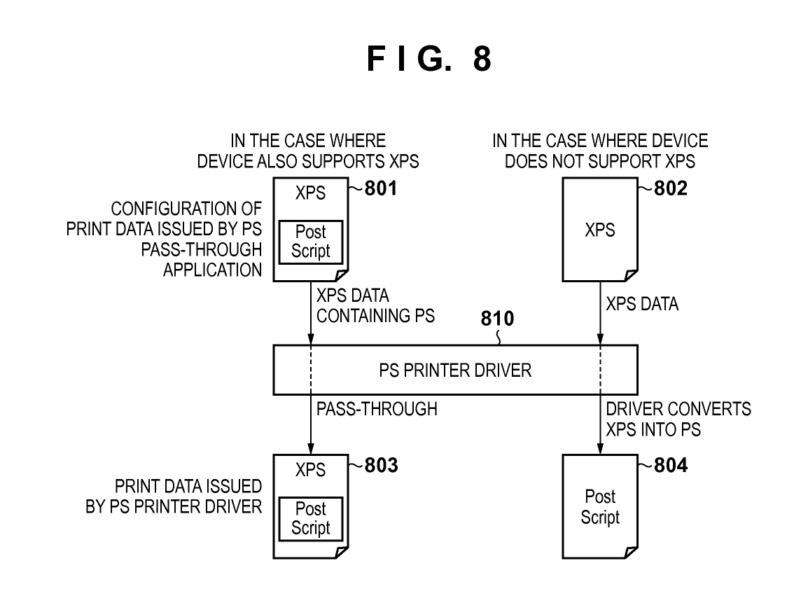

The application 603 determines whether or not the PS printer driver 604 used for printing can handle PS Pass-Through using the notification (reply information) received from the PS printer driver 604. If the PS printer driver 604 can handle PS Pass-Through (YES at S06), the application 603 generates PS format print data on its own as in the conventional operation. In this case, to adjust to the printing system in which data is handled in the fixed format, the application 603 causes the PS format print data generated on its own to be contained in the XPS format data, which is the fixed format (print data 801 in FIG. 8). Then the application 603 transmits this data as print data 607 to the PS printer driver 604 (S07).

The PS printer driver 604 transmits the XPS format print data containing the PS format print data generated by the application 603 as it is to a print port designated as an output designation of the PS printer driver 604 without processing the XPS print format data (S09). That is, the PS printer driver 604 transmits the print data as print data 609 in FIG. 6 to the printer 602. Then, the printer 602 extracts the contained PS format print data, expands it into rendering data, and executes printing based on the content of description of the print data 609.

Meanwhile, if the PS printer driver 604 used for printing is a printer driver that does not support PS Pass-Through (NO at S06), the application 603 does not generate PS format print data. In this case, the application 603 transmits the XPS format print data as the print data 607 to the PS printer driver 604. Then the application 603 instructs the PS printer driver 604 to generate print data. In other words, the PS printer driver 604 converts the print data 607 instructed in the XPS format into print data 608 in the PS format (S08). Then, at S09, the PS printer driver 604 transmits the print data 608 converted into the PS format data as print data to the printer 602. After that, the printer 902 expands the print data into rendering data and executes printing based on the content of description of the PS format print data 908 converted by the PS printer driver 904. After that, the processing ends.

FIG. 8 shows the states of the print data before and after being processed by the printer driver in the present embodiment. The print data 801 has a data structure generated by the application in the case where the printer supports XPS. The print data 801 represents the state where PS format print data is contained in the XPS format print data, and at the time of pass-through the PS printer driver 810 transmits the print data, without processing it, as it is as print data 803 to the printer 602.

Print data 802 is in the data format (here, XPS format) generated by the application in the case where the printer does not support the XPS format. The application generates the XPS format print data 802 and passes it to the PS printer driver 810. Therefore, the PS printer driver 810 converts the XPS format print data 802 acquired from the application into PS format print data 804.

With the above-described configuration, in the printing system, print data in an appropriate data format can be generated in accordance with the state of a printer serving as a printing unit.

In the present embodiment, PostScript is taken as an example of the printer language that can be executed by the printer, but the printer language is not limited thereto. For example, other PDLs such as PCL (Printer Control Language) may also be used. Further, instead of XPS, EMF (Enhanced Metafile) may be used.

Further, in this embodiment, the user interface application has the functions of making an inquiry to the printer, receiving print settings, and the like, but the functions are not limited thereto. For example, the user interface application may be caused to perform functions common to printer drivers installed on the client terminal, thereby simplifying the functions each printer driver has.

### Second Embodiment

FIG. 1 to FIG. 4 and FIG. 9 to FIG. 11 depict the second embodiment. The description of FIG. 1 to FIG. 4, which are the same as in the first embodiment, will be omitted.

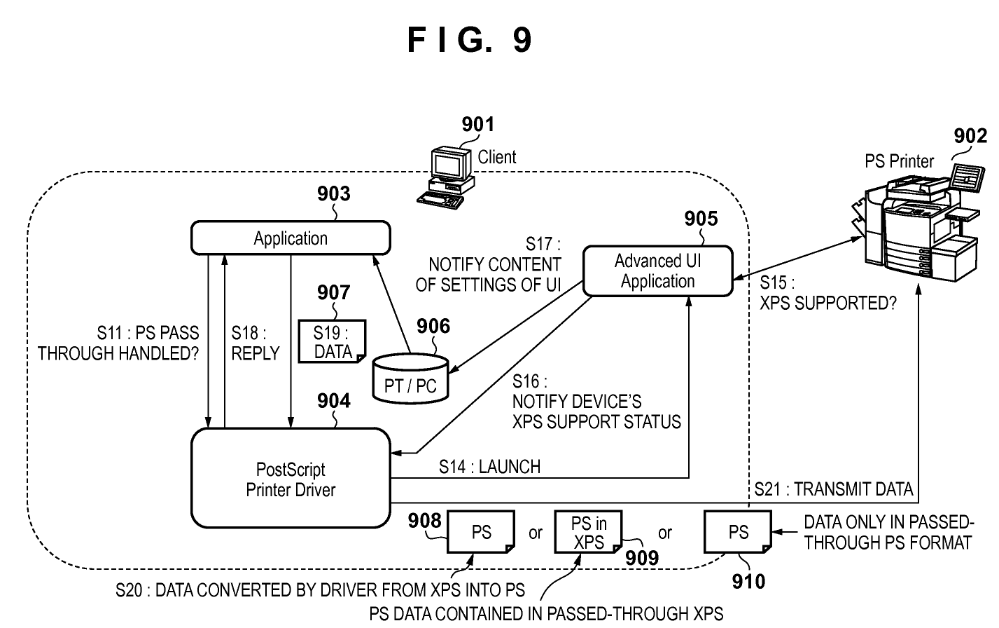

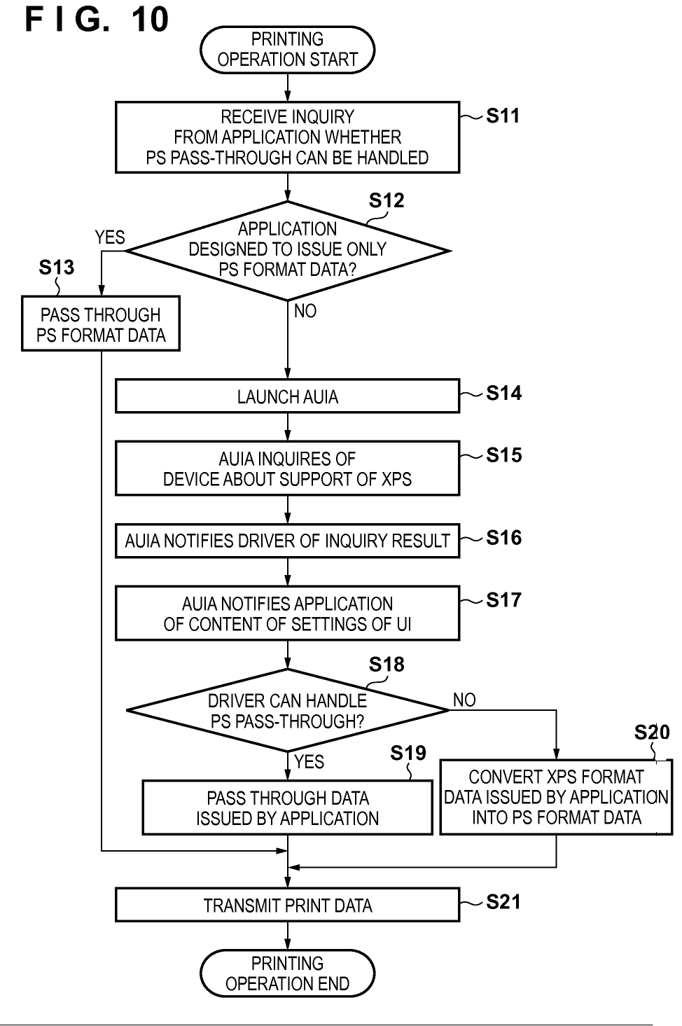

FIG. 9 shows a printing system in which print data is handled in a fixed format according to the present embodiment. FIG. 10 shows a flowchart for the printing system. In FIG. 9 and FIG. 10, the same reference numeral indicates the same process. Also in the following description, XPS is used as the fixed format, and PS is used as the printer language.

An application 903 for document generation, drawing, spreadsheet, or the like has been installed on a client computer 901. When printing is executed from the application 903, an instruction to generate print data is given in advance to a PS printer driver 904 installed on the client computer 901. At this time, the PS printer driver 904 receives an inquiry from the application 903 about whether or not the printer driver can handle PS Pass-Through (S11).

Upon receiving the above inquiry, the PS printer driver 904 performs determination about the application 903 based on the name and version information of the application 903 that made the inquiry. Specifically, it checks whether the application 903 issues print data containing PS format print data in the fixed format or issues only PS format print data. Methods with which the PS printer driver 904 acquires information about the application that made the inquiry include, for example, GetParent function on Windows OS. The function of the application may also be checked, for example, based on the information acquired through the inquiry and information registered in advance on a held list or the like.

If, as a result of the above check, the application 903 issues only PS format print data (YES at S12), the PS printer driver 904 does not process print data only in the PS format issued by the application 903. In this case, the application 903 transmits the received PS format print data as it is to a print port set as an output destination of the PS printer driver 904 (S13).

Meanwhile, if the application 903 does not issue print data only in the PS format (NO at S12), the PS printer driver 904 launches an AUIA 905 capable of changing various print settings and the like (S14). Then, the AUIA 905 inquires of the printer 902 designated in advance as a printing destination about whether or not the printer 902 supports XPS (S15). This inquiry is the same as in the first embodiment.

After acquiring information about whether or not the printer 902 used for printing supports XPS, the AUIA 905 notifies the PS printer driver 904 (S16). The AUIA 905 also generates setting information 906 necessary for generating print data and passes the setting information 906 together with the information about whether or not the printer 902 used for printing supports XPS to the application 903 (S17). The setting information 906 used here is the same as in the first embodiment.

The PS printer driver 904 makes a reply to the application 903 about whether or not the PS printer driver 904 can handle PS Pass-Through based on the information received from the AUIA 905 about whether or not the printer 902 used for printing supports XPS (S18). This reply is the same as in the first embodiment.

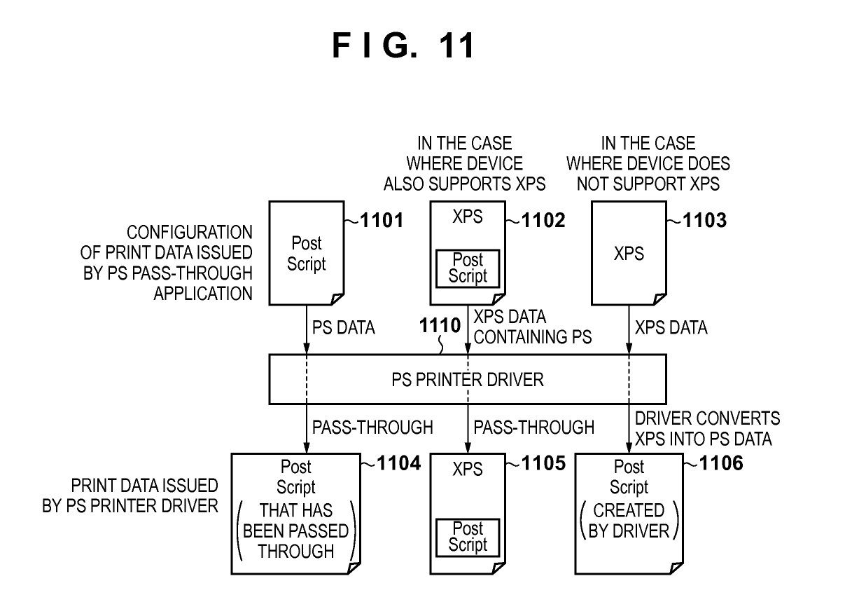

The application 903 determines whether or not the PS printer driver 904 used for printing can handle PS Pass-Through based on the notification (reply information) received from the PS printer driver 904. If the PS printer driver 904 can handle PS Pass-Through (YES at S18), the application 903 generates print data 907 in the PS format on its own as described in the operation in the conventional technique. In this case, to adjust to the printing system where the data is handled in the fixed format, the application 903 causes the PS format print data generated on its own to be contained in the fixed format data (print data 1102 in FIG. 11). Then the application 903 transmits this print data as print data 907 to the PS printer driver 904 (S19).

The PS printer driver 904 transmits the XPS format print data containing the PS format print data generated by the application 903 as it is to a port set as an output designation of the PS printer driver 904 without processing the XPS format print data (S21). That is, the PS printer driver 904 transmits the print data as print data 909 in FIG. 9 to the printer 902. Then, the printer 902 extracts the contained PS data, expands the data into rendering data, and executes printing based on the content of description of the print data 909.

Meanwhile, if the PS printer driver 904 used for printing is a printer driver that cannot handle PS Pass-Through (NO at S18), the application 903 does not generate print data in the PS format. In this case, the application 903 transmits XPS format print data as the print data 907 to the PS printer driver 904. In other words, the PS printer driver 904 converts the print data 607 instructed in the XPS format into print data 908 in the PS format (S20). Then, at S21, the PS printer driver 904 transmits the print data 908 converted into the PS format data as the print data to the printer 902. The printer 902 expands the print data into rendering data and executes printing based on the content of description of the PS format print data 908 converted by the PS printer driver 904.

FIG. 11 depicts the states of print data before and after being processed by the printer driver in the present embodiment. Print data 1101 has a pass-through data configuration only using PS format print data. The print data 1102 shows the state where PS format print data is contained in XPS format print data. At the time of PS Pass-Through, a PS printer driver 1110 transmits print data, without processing it, as it is as print data 1104 or 1105 to the printer 902.

Meanwhile, print data 1103 is in the data format (here, XPS format) generated by the application in the case where the printer does not support the XPS format. The application generates XPS format print data 1103 and passes it to the PS printer driver 1110. Therefore, the PS printer driver 1110 converts the XPS format print data 1103 acquired from the application into PS format print data 1106.

With the above-described configuration, in the printing system, print data in an appropriate data format can be generated in accordance with the state of the printing unit or the function of the application.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2011-152344, filed Jul. 8, 2011, which is hereby incorporated by reference herein in its entirety.

What is claimed is:

1. An information processing apparatus including a printer driver for a printing apparatus that supports a first data format and an application for generating data in accordance with the data format supported by the printing apparatus, the information processing apparatus comprising:
a determination unit configured to determine whether or not the printing apparatus supports a second data format; and
a transmission unit configured to transmit, to the printing apparatus, data generated by the application in the second data format that contains data in the first data format as it is if the determination unit determines that the printing apparatus supports the second data format, and convert data generated by the application in the second data format into the first data format using a function of the printer driver and transmit the converted data to the printing apparatus if the determination unit determines that the printing apparatus does not support the second data format.

2. The information processing apparatus according to claim 1, further comprising an acquisition unit configured to acquire, from the printing apparatus, information about a data format supported by the printing apparatus,
wherein the determination unit performs determination using the information acquired by the acquisition unit.

3. The information processing apparatus according to claim 1, further comprising a notification unit configured to notify the application of a result of determination by the determination unit.

4. The information processing apparatus according to claim 1, further comprising a confirmation unit configured to confirm a data format of data generated by the application,
wherein if, as a result of the confirmation by the confirmation unit, the application generates data only in the first data format, the transmission unit transmits data generated by the application in the first data format as it is to the printing apparatus.

5. The information processing apparatus according to claim 1, wherein the first data format is PostScript or PCL (Printer Control Language).

6. The information processing apparatus according to claim 1, wherein the second data format is XPS (XML Paper Specification).

7. A method for controlling an information processing apparatus including a printer driver for a printing apparatus that supports a first data format and an application for generating data in accordance with the data format supported by the printing apparatus, the method comprising:
determining whether or not the printing apparatus supports a second data format; and
transmitting, to the printing apparatus, data generated by the application in the second data format that contains data in the first data format as it is if it is determined during the determining that the printing apparatus supports the second data format, and converting data generated by the application in the second data format into the first data format using a function of the printer driver and transmitting the converted data to the printing apparatus if it is determined during the determining that the printing apparatus does not support the second data format.

8. The control method according to claim 7, wherein the second data format is XPS (XML Paper Specification).

9. A computer-readable medium storing a program for causing a computer to function as:
a determination unit configured to determine whether or not the printing apparatus, which supports a first data format, supports a second data format; and
a transmission unit configured to transmit, to the printing apparatus, data generated by the application in the second data format that contains data in the first data format as it is if the determination unit determines that the printing apparatus supports the second data format, and convert data generated by the application in the second data format into the first data format and transmit the converted data to the printing apparatus if the determination unit determines that the printing apparatus does not support the second data format.
